(19) United States
(12) Patent Application Publication
(10) Pub. No.: US 2005/0050737 A1
(43) Pub. Date: Mar. 10, 2005

(54) Hair coloring device

(76) Inventor: Kam Fai Fung, Tuen Mun (HK)

Correspondence Address: STEVEN A. GARNER;CONAIR CORPORATION, ONE CUMMINGS POINT ROAD, STAMFORD, CT, 06902, US

(21) Appl. No.: 10/935,988

(22) Filed: Sep. 8, 2004

Related U.S. Application Data
(60) Provisional application No. 60/501,119, filed on Sep. 8, 2003.

(51) Int. Cl. B26B 19/00

(52) U.S. Cl. 30/199

(57) ABSTRACT

A delivery system for a hair-coloring and streaking device by combining, in a single hand held appliance, a motor driven piston and a modular liquid colorant container, in combination with an efficient spring-loaded clip and comb. The invention features a carefully controlled interface between the hair and the liquid delivery system and a feature that reverses the motor automatically when the device is shut off in order to empty the manifold back into the reservoir and to prevent subsequent leakage of fluid. In addition the invention includes a modular dye package employing an accordion pleated bottle that allows reliable pressurizing with a simple motor driven piston.

### CROSS-REFERENCE TO RELATED APPLICATIONS

This application claims priority to U.S. Provisional Patent Application Ser. No. 60/501,119 filed on Sep. 8, 2003, incorporated herein by reference in its entirety.

### BACKGROUND OF THE INVENTION

1. Field of the Invention

The present invention relates to an improved device to color or otherwise apply a prepackaged liquid to sections of hair.

2. Description of Related Art

It is known in the art to employ hollow combs, which connect reservoirs of liquid hair colorant to openings in a portion of a comb shaped manifold, to distribute color onto strands of hair. Coloring selected strands of hair in colors contrasting the natural hair color is called streaking and is a popular hair ornamentation. The various prior art devices have encountered difficulty distributing the coloring liquid in a controlled and predictable manner, without inadvertently spilling the colorant and inadvertently coloring adjacent hairs. There is need for an improved applicator for delivering colorant accurately to the selected hair tress.

Prior art devices have employed refillable elastomeric bulbs, piston cylinders and compressible bottles to contain the colorant or fluid. These reservoirs have then been pressurized by squeezing the bulb directly or by compressing the bulb with various mechanical or pneumatic devices. Prior art application devices have, however, had difficulty with left over liquid remaining in the manifold cavity and leaking after the device has been disengaged. There is need for a system to relieve pressure on the liquid after applications and to evacuate the manifold cleanly.

Prior art hair coloring systems that require refilling have necessitated the handling of messy colored fluids. Prior art systems which have employed prepackaged liquids, in order to avoid such problems, have been pressurized by compressed gases. Such systems require charged containers of volatile gases or air compressors, which are expensive and inconvenient. There is need, therefore, for a simple mechanical system, in a convenient package, which can automatically deliver liquid colorant to the hair and which utilizes prepackaged liquid containers.

### BRIEF SUMMARY OF THE INVENTION

It is an object of the present invention to provide a hair-coloring device and associated method that overcomes the shortcomings of the prior art mentioned above. These and other objects are achieved by the present invention described herein.

The present invention improves the delivery system for a hair-coloring and streaking device by combining, in a single hand held appliance, a motor driven piston and a modular liquid colorant container, in combination with an efficient spring-loaded clip and comb. The invention features a carefully controlled interface between the hair and the liquid delivery system and a feature that reverses the motor automatically when the device is shut off in order to empty the manifold back into the reservoir and to prevent subsequent leakage of fluid. In addition the invention includes a modular dye package employing an accordion pleated bottle that allows reliable pressurizing with a simple motor driven piston.

### BRIEF DESCRIPTION OF THE DRAWINGS

The present invention is more fully understood by reference to the following detailed description of an illustrative embodiment with the drawings identified below.

FIG. 1 is an illustration of the preferred embodiment of the hair-coloring device.

FIG. 2 is a schematic illustration of the preferred embodiment of the hair-coloring device, illustrating the assembled components.

FIG. 3 is an exploded view of the preferred embodiment of the hair-coloring device.

FIG. 4 is an illustration of the assembly of the preferred coloring head.

### DETAILED DESCRIPTION OF THE INVENTION

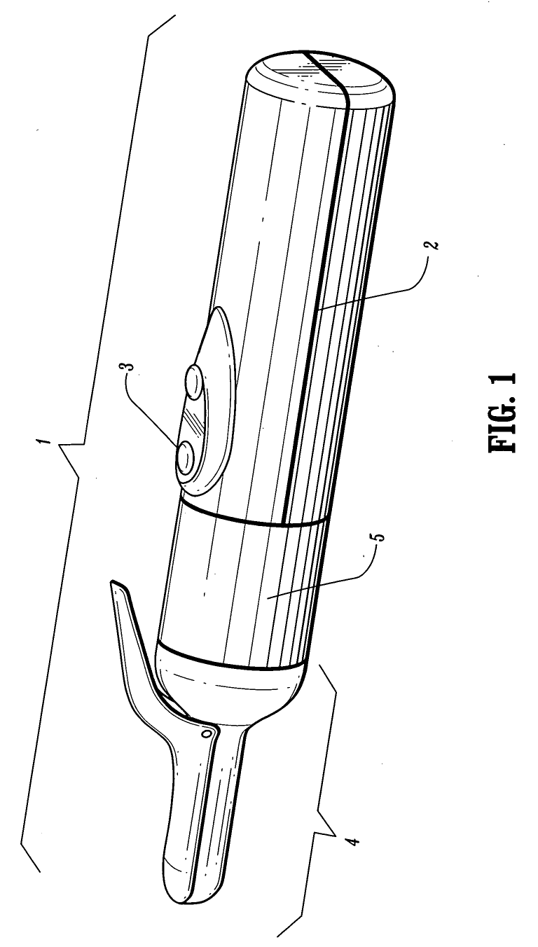

Referring to FIG. 1, the preferred embodiment of the present invention (1), an improved electrical device for streaking color into hair, is illustrated in a schematic view. The appliance overall (1) is made up of a handle section (2) a switch (3) a reservoir housing (5) and a coloring head (4).

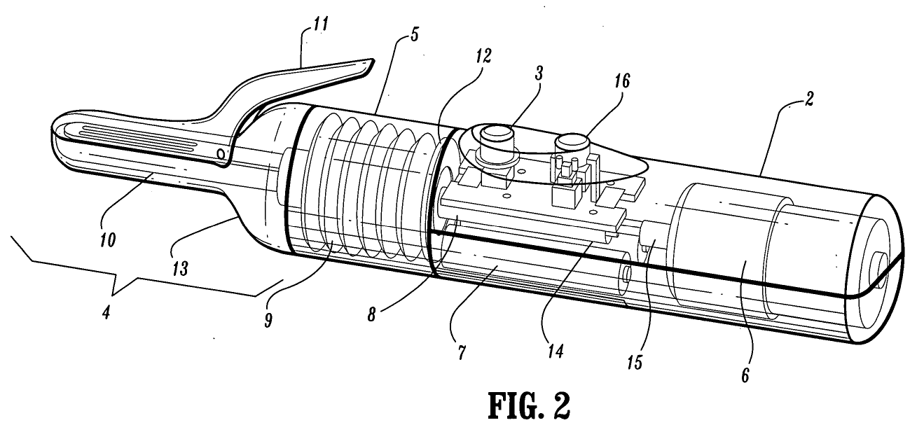

FIG. 2 illustrates the preferred embodiment of the hair-coloring tool, displaying the internal components ghosted in their assembled positions. The coloring head assembly (4) is made up of a housing (13), a comb and clip (11) and a manifold tube (10). The manifold tube is open to the reservoir, via an interference or threaded seal (20), which, in the preferred embodiment, is a blow molded, accordion pleated bottle (9). The bottle is seated upon a moving piston (12) which is driven by a threaded shaft (14) engaging a rotating thread (15) which is couple to the output of a DC motor (6). Controls (3) and (16) switch the motor direction to drive the piston (12) forward or back. The motor switches are mounted on circuit board (8) and the motor is powered by batteries (7). Alternative embodiments could also be powered off mains through a line cord and swivel (not shown).

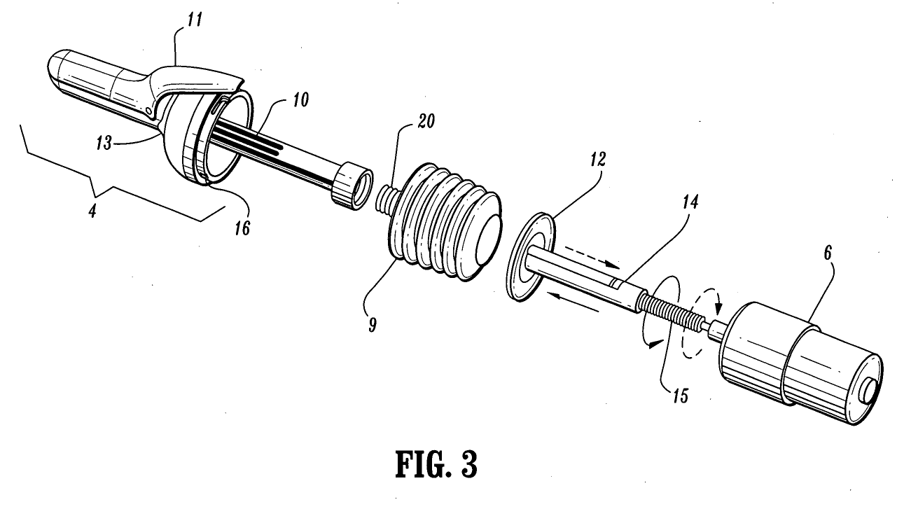

FIG. 3 illustrates the components of the preferred embodiment in an exploded assembly. A bayonet lock detail (16) is shown on the color head housing (13). The bayonet lock engages the reservoir housing (5) and allows the color reservoir bottle (9) to be accessed and replaced. This allows empty bottles to be changed out and alternate colors to be loaded. The reservoir bottle (9) is sealed into the tube manifold (10) and when the piston (12) is driven forward, color is displaced in an amount metered by the motor speed. The motor speed can be a fixed RPM or in the preferred embodiment it can be a variable RPM, controlled by the position of switch (3). The circuit board (8) supports components that comprise the control circuit. A unique feature of the control employed in the preferred embodiment is that it automatically reverses the forward motion of the piston (12) when switch (3) is released. The reversing of the motor is momentary and sufficient to relieve pressure in the manifold (10) and return the liquid agent, which is resident in the manifold (10), back to the reservoir (9). This feature improves control of the color application and avoids untoward leaking.

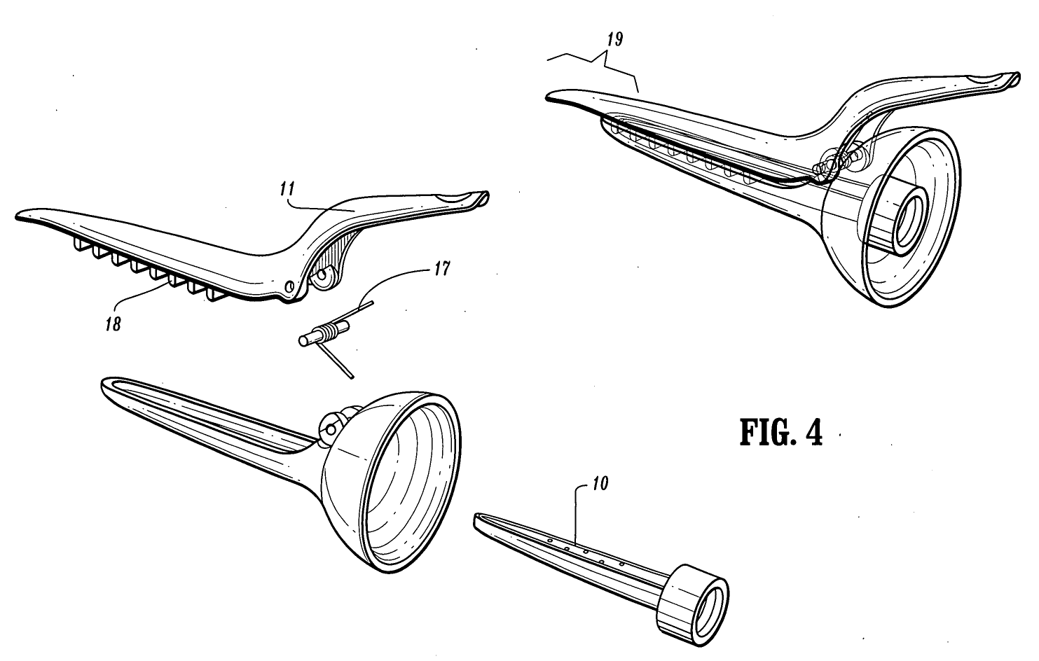

FIG. 4 illustrates exploded and ghosted assemblies of the preferred color head (4). The components of the color head (4) include the manifold tube (10) which delivers color to the hair from the reservoir bottle (9). The clip (11) features a tip for gathering hair into the clip (19) and a series of combs (18) to maintain the spread of the hair tress over the manifold (10). The clip is biased against the housing (13) and manifold tube (10). The manifold tube is replaceable and can be changed out with the color bottle (9). The pattern of holes in the manifold tube (10) and of pattern of combs (18) which are molded into the spring clip (11) are designed to spread the coloring fluid evenly into the hair in a controlled and predictable manner.

While a preferred embodiment of the invention has been herein disclosed and described, it is understood that various modifications can be made without departing from the scope of the invention.

1. A hair coloring device comprising:
a handle;
a flexible container near an end of said handle for holding a liquid colorant;
a piston adjacent said container adapted to displace said liquid colorant from said container when said piston is moved into contact with said container causing said container to flex; and
a coloring head adjacent said container adapted to deliver said liquid colorant received from said container to said hair.

2. A hair coloring device according to claim 1, further comprising
a motor within said handle to drive said piston, wherein said motor is reversible to reverse the motion of said piston.

3. A hair coloring device according to claim 1, further comprising
a first button on said handle for operating said motor to selectively drive said piston in a first direction to flex said container.

4. A hair coloring device according to claim 3, further comprising
a second button on said handle for operating said motor to selectively drive said piston in a second direction to enable said container to expand itself.

5. A hair coloring device according to claim 3, wherein
said first button is adapted to, upon release, momentarily reverse said motor to move said piston in said second direction such that said liquid colorant moves from said coloring head to said container.

6. A hair coloring device according to claim 1, wherein
said coloring head further comprises a tube adapted to transfer liquid colorant from said container to said hair.

7. A hair coloring device according to claim 6, wherein
said coloring head further comprises a clip for holding said hair in said coloring head.

8. A hair coloring device according to claim 7, wherein
said coloring head further comprises
a plurality of combs adapted to maintain the spread of said hair over said tube; and
a plurality of holes in said tube for the application of said liquid colorant to said hair in a controlled and predetermined manner.

9. A hair coloring device according to claim 1, wherein
said container is an accordion-pleated bottle adapted to be changeable or replaceable.

10. A hair coloring device according to claim 2, wherein
said motor operates at a fixed speed.

11. A hair coloring device according to claim 2, wherein
said motor operates at a variable speed controlled by the position of said first button or said second button.

12. A hair coloring device according to claim 2, wherein
said motor actuates said piston through a threaded shaft that engages a rotating thread coupled to said motor.
